(19) United States
(12) Patent Application Publication
(10) Pub. No.: US 2018/0189039 A1
(43) Pub. Date: Jul. 5, 2018

(54) AUTOMATIC GENERATION OF MANUAL CODING SUGGESTIONS FOR CONVERSION OF APPLICATION PROGRAMS TO OFF-LINE ENVIRONMENT

(71) Applicant: General Electric Company, Schenectady, NY (US)

(72) Inventors: Michael HART, San Ramon, CA (US); Milton WAID, San Ramon, CA (US); Jeremy OSTERHOUDT, San Ramon, CA (US); Andy JOHNS, San Ramon, CA (US)

(21) Appl. No.: 15/394,323

(22) Filed: Dec. 29, 2016

(51) Int. Cl. G06F 9/45

(52) U.S. Cl. CPC G06F 8/447; H04W 4/001

(57) ABSTRACT

A method includes machine reading a first code listing. The first code listing represents at least a portion of an application program. The machine-reading proceeds through a plurality of segments of the first code listing. A processor determines, during the machine-reading, that one of the plurality of segments is of a predetermined type. In response to that determination, an indication of a suggested manual coding approach is automatically appended to a second code listing. The suggested manual coding approach is for converting the first code listing segment for use in the second code listing.

### BACKGROUND

Industrial equipment or assets, generally, are engineered to perform particular tasks as part of a business process. For example, industrial assets can include, among other things and without limitation, manufacturing equipment on a production line, wind turbines that generate electricity on a wind farm, healthcare or imaging devices (e.g., X-ray or MRI systems) for use in patient care facilities, or drilling equipment for use in mining operations. The design and implementation of these assets often takes into account both the physics of the task at hand, as well as the environment in which such assets are configured to operate.

Low-level software and hardware-based controllers have long been used to drive industrial assets. However, the rise of inexpensive cloud computing, increasing sensor capabilities, and decreasing sensor costs, as well as the proliferation of mobile technologies have created opportunities for creating novel industrial assets with improved sensing technology that are capable of transmitting data that can then be transmitted to a network. As a consequence, there are new opportunities to enhance the business value of some industrial assets using novel industrial-focused hardware and software.

One important aspect of the use of data generated by industrial assets and other types of devices is that the data may be distributed to mobile devices (e.g., smartphones, tablet computers) carried by individuals who are “on the go” but need or wish to be kept up to date on the data produced or stored in a network. Previous proposals for distributing data from central data repositories have often assumed that devices intended to receive the data from a central source are connected to the central source by reliable and substantially uninterrupted communication channels. The application programs in the recipient devices and the central data source that engage in data communication, transmission and reception may be designed to operate on the assumption of substantially continuous data communication connectivity between source and recipient devices. However, that assumption may not hold if mobile devices are to be the recipients of the data. Accordingly, it has been proposed to convert existing web and mobile applications so as to function effectively in environments where connectivity between the source and recipient devices may be subject to frequent interruption. Web and mobile applications for such purposes have previously been converted to function off-line (i.e., with interruptible connectivity) by manually coding suitable adapter programs or “splices”. The manual coding employed in these instances is time-consuming and expensive.

### BRIEF DESCRIPTION OF THE DRAWINGS

FIG. 1 illustrates generally an example of portions of a first asset management platform (AMP).

FIG. 2 is a high level block diagram showing other aspects of the AMP depicted in FIG. 1.

FIG. 3 is a block diagram of a typical mobile device such as those shown in FIG. 2.

FIG. 4 is a block diagram of an automatic application program conversion system according to some embodiments.

FIGS. 5, 6 and 7 are flow charts that illustrate processes performed according to some embodiments.

FIG. 8 schematically illustrates an application program code listing to be processed by the system of FIG. 4.

FIG. 9 schematically illustrates a converted application program code listing generated by the system of FIG. 4 from the code listing of FIG. 8.

FIG. 10 is a block diagram of a computing system according to some embodiments.

### DETAILED DESCRIPTION

While progress with industrial equipment automation has been made over the last several decades, and assets have become ‘smarter,’ the intelligence of any individual asset pales in comparison to intelligence that can be gained when multiple smart devices are connected together. Aggregating data collected from or about multiple assets can enable users to improve business processes, for example by improving effectiveness of asset maintenance or improving operational performance if appropriate industrial-specific data collection and modeling technology is developed and applied.

In an example, an industrial asset can be outfitted with one or more sensors configured to monitor respective ones of an asset's operations or conditions. Data from the one or more sensors can be recorded or transmitted to a cloud-based or other remote computing environment. By bringing such data into a cloud-based computing environment, new software applications informed by industrial process, tools and know-how can be constructed, and new physics-based analytics specific to an industrial environment can be created. Insights gained through analysis of such data can lead to enhanced asset designs, or to enhanced software algorithms for operating the same or similar asset at its edge, that is, at the extremes of its expected or available operating conditions.

The systems and methods for managing industrial assets can include or can be a portion of an Industrial Internet of Things (IIoT). In an example, an IIoT connects industrial assets, such as turbines, jet engines, and locomotives, to the Internet or cloud, or to each other in some meaningful way. The systems and methods described herein can include using a “cloud” or remote or distributed computing resource or service. The cloud can be used to receive, relay, transmit, store, analyze, or otherwise process information for or about one or more industrial assets. In an example, a cloud computing system includes at least one processor circuit, at least one database, and a plurality of users or assets that are in data communication with the cloud computing system. The cloud computing system can further include or can be coupled with one or more other processor circuits or modules configured to perform a specific task, such as to perform tasks related to asset maintenance, analytics, data storage, data exchange, security, or some other function.

However, the integration of industrial assets with the remote computing resources to enable the IIoT often presents technical challenges separate and distinct from the specific industry and from computer networks, generally. A given industrial asset may need to be configured with novel interfaces and communication protocols to send and receive data to and from distributed computing resources. Given industrial assets may have strict requirements for cost, weight, security, performance, signal interference, and the like such that enabling such an interface is rarely as simple as combining the industrial asset with a general purpose computing device.

To address these problems and other problems resulting from the intersection of certain industrial fields and the IIoT, embodiments may enable improved interfaces, techniques, protocols, and algorithms for facilitating communication with and configuration of industrial assets via remote computing platforms and frameworks. Improvements in this regard may relate to both improvements that address particular challenges related to particular industrial assets (e.g., improved aircraft engines, wind turbines, locomotives, medical imaging equipment) that address particular problems related to use of these industrial assets with these remote computing platforms and frameworks, and also improvements that address challenges related to operation of the platform itself to provide improved mechanisms for configuration, analytics, and remote management of industrial assets as well as distribution of resulting data to individuals who work with or need data generated by industrial assets.

The Predix™ platform available from GE is a novel embodiment of such Asset Management Platform (AMP) technology enabled by state of the art cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial assets can be uniquely situated to leverage its understanding of industrial assets themselves, models of such assets, and industrial operations or applications of such assets, to create new value for industrial customers through asset insights.

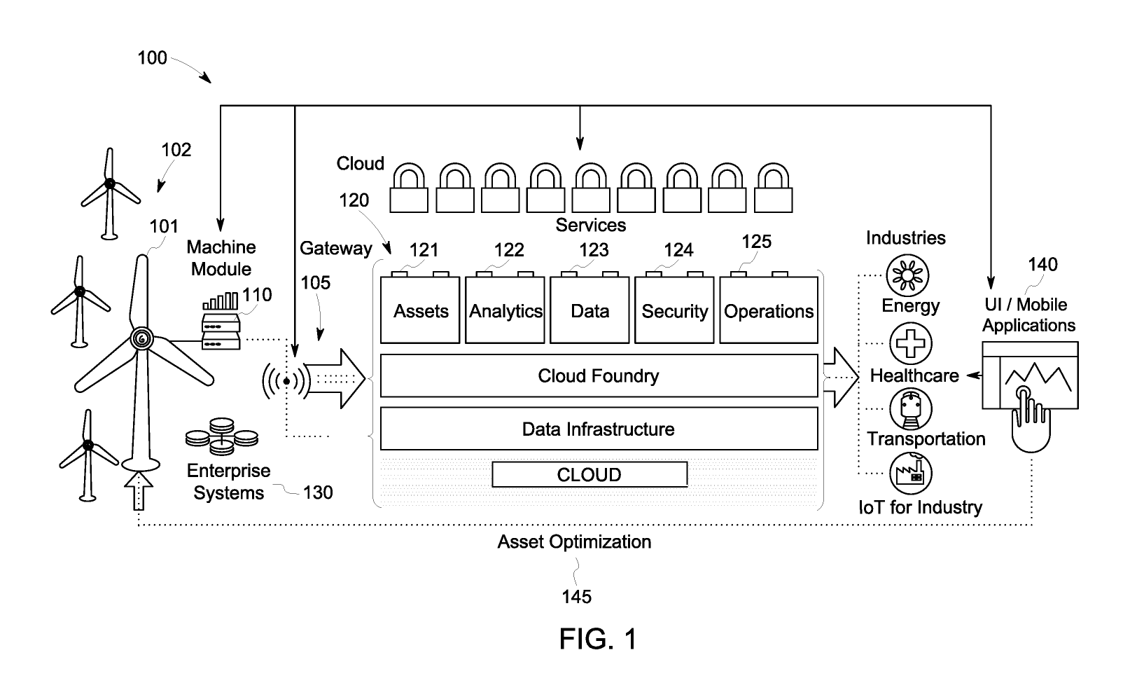

FIG. 1 illustrates generally an example of portions of a first AMP 100. As further described herein, one or more portions of an AMP can reside in an asset cloud computing system 120, in a local or sandboxed environment, or can be distributed across multiple locations or devices. An AMP can be configured to perform any one or more of data acquisition, data analysis, or data exchange with local or remote assets, or with other task-specific processing devices.

The first AMP 100 includes a first asset community 102 that is communicatively coupled with the asset cloud computing system 120. In an example, a machine module 110 receives information from, or senses information about, at least one asset member of the first asset community 102, and configures the received information for exchange with the asset cloud computing system 120. In an example, the machine module 110 is coupled to the asset cloud computing system 120 or to an enterprise computing system 130 via a communication gateway 105.

In an example, the communication gateway 105 includes or uses a wired or wireless communication channel that extends at least from the machine module 110 to the asset cloud computing system 120. The asset cloud computing system 120 includes several layers. In an example, the asset cloud computing system 120 includes at least a data infrastructure layer, a cloud foundry layer, and modules for providing various functions. In the example of FIG. 1, the asset cloud computing system 120 includes an asset module 121, an analytics module 122, a data acquisition module 123, a data security module 124, and an operations module 125. (In some embodiments, the asset cloud computing system may also include a data distribution module—not separately shown—which may at least partially overlap with the data acquisition module 123.) Each of the modules 121-125 includes or uses a dedicated circuit, or instructions for operating a general purpose processor circuit, to perform the respective functions. In an example, the modules 121-125 are communicatively coupled in the asset cloud computing system 120 such that information from one module can be shared with another. In an example, the modules 121-125 are co-located at a designated datacenter or other facility, or the modules 121-125 can be distributed across multiple different locations.

An interface device 140 can be configured for data communication with one or more of the machine module 110, the gateway 105, or the asset cloud computing system 120. The interface device 140 can be used to monitor or control one or more assets. In an example, information about the first asset community 102 is presented to an operator at the interface device 140. The information about the first asset community 102 can include information from the machine module 110, or the information can include information from the asset cloud computing system 120. In an example, the information from the asset cloud computing system 120 includes information about the first asset community 102 in the context of multiple other similar or dissimilar assets, and the interface device 140 can include options for optimizing one or more members of the first asset community 102 based on analytics performed at the asset cloud computing system 120.

In an example, an operator selects a parameter update for the first wind turbine 101 using the interface device 140, and the parameter update is pushed to the first wind turbine via one or more of the asset cloud computing system 120, the gateway 105, and the machine module 110. In an example, the interface device 140 is in data communication with the enterprise computing system 130 and the interface device 140 provides an operation with enterprise-wide data about the first asset community 102 in the context of other business or process data. For example, choices with respect to asset optimization can be presented to an operator in the context of available or forecasted raw material supplies or fuel costs. In an example, choices with respect to asset optimization can be presented to an operator in the context of a process flow to identify how efficiency gains or losses at one asset can impact other assets. In an example, one or more choices described herein as being presented to a user or operator can alternatively be made automatically by a processor circuit according to earlier-specified or programmed operational parameters. In an example, the processor circuit can be located at one or more of the interface device 140, the asset cloud computing system 120, the enterprise computing system 130, or elsewhere.

Returning again to the example of FIG. 1, some capabilities of the first AMP 100 are illustrated. The example of FIG. 1 includes the first asset community 102 with multiple wind turbine assets, including the first wind turbine 101. Wind turbines are used in some examples herein as non-limiting examples of a type of industrial asset that can be a part of, or in data communication with, the first AMP 100.

In an example, the multiple turbine members of the asset community 102 include assets from different manufacturers or vintages. The multiple turbine members of the asset community 102 can belong to one or more different asset communities, and the asset communities can be located locally or remotely from one another. For example, the members of the asset community 102 can be colocated on a single wind farm, or the members can be geographically distributed across multiple different farms. In an example, the multiple turbine members of the asset community 102 can be in use (or non-use) under similar or dissimilar environmental conditions, or can have one or more other common or distinguishing characteristics.

FIG. 1 further includes the device gateway 105 configured to couple the first asset community 102 to the asset cloud computing system 120. The device gateway 105 can further couple the asset cloud computing system 120 to one or more other assets or asset communities, to the enterprise computing system 130, or to one or more other devices, including mobile devices, as discussed below. The first AMP 100 thus represents a scalable industrial solution that extends from a physical or virtual asset (e.g., the first wind turbine 101) to a remote asset cloud computing system 120. The asset cloud computing system 120 optionally includes a local, system, enterprise, or global computing infrastructure that can be optimized for industrial data workloads, secure data communication, and compliance with regulatory requirements.

In an example, information from an asset, about the asset, or sensed by an asset itself is communicated from the asset to the data acquisition module 124 in the asset cloud computing system 120. In an example, an external sensor can be used to sense information about a function of an asset, or to sense information about an environment condition at or near an asset. The external sensor can be configured for data communication with the device gateway 105 and the data acquisition module 124, and the asset cloud computing system 120 can be configured to use the sensor information in its analysis of one or more assets, such as using the analytics module 122.

In an example, the first AMP 100 can use the asset cloud computing system 120 to retrieve an operational model for the first wind turbine 101, such as using the asset module 121. The model can be stored locally in the asset cloud computing system 120, or the model can be stored at the enterprise computing system 130, or the model can be stored elsewhere. The asset cloud computing system 120 can use the analytics module 122 to apply information received about the first wind turbine 101 or its operating conditions (e.g., received via the device gateway 105) to or with the retrieved operational model. Using a result from the analytics module 122, the operational model can optionally be updated, such as for subsequent use in optimizing the first wind turbine 101 or one or more other assets, such as one or more assets in the same or different asset community. For example, information about the first wind turbine 101 can be analyzed at the asset cloud computing system 120 to inform selection of an operating parameter for a remotely located second wind turbine that belongs to a different second asset community.

The first AMP 100 includes a machine module 110. The machine module 110 includes a software layer configured for communication with one or more industrial assets and the asset cloud computing system 120. In an example, the machine module 110 can be configured to run an application locally at an asset, such as at the first wind turbine 101. The machine module 110 can be configured for use with or installed on gateways, industrial controllers, sensors, and other components. In an example, the machine module 110 includes a hardware circuit with a processor that is configured to execute software instructions to receive information about an asset, optionally process or apply the received information, and then selectively transmit the same or different information to the asset cloud computing system 120.

In an example, the asset cloud computing system 120 can include the operations module 125. The operations module 125 can include services that developers can use to build or test Industrial Internet applications, or the operations module 125 can include services to implement Industrial Internet applications, such as in coordination with one or more other AMP modules. In an example, the operations module 125 includes a microservices marketplace where developers can publish their services and/or retrieve services from third parties. The operations module 125 can include a development framework for communicating with various available services or modules. The development framework can offer developers a consistent look and feel and a contextual user experience in web or mobile applications.

In an example, an AMP can further include a connectivity module. The connectivity module can optionally be used where a direct connection to the cloud is unavailable. For example, a connectivity module can be used to enable data communication between one or more assets and the cloud using a virtual network of wired (e.g., fixed-line electrical, optical, or other) or wireless (e.g., cellular, satellite, or other) communication channels. In an example, a connectivity module forms at least a portion of the gateway 105 between the machine module 110 and the asset cloud computing system 120, and/or between the asset cloud computing system 120 and other components of the AMP 100, including for example mobile devices (as discussed below) and/or fixed-location data-receiving devices.

In an example, an AMP can be configured to aid in optimizing operations or preparing or executing predictive maintenance for industrial assets. An AMP can leverage multiple platform components to predict problem conditions and conduct preventative maintenance, thereby reducing unplanned downtimes. In an example, the machine module 110 is configured to receive or monitor data collected from one or more asset sensors and, using physics-based analytics (e.g., finite element analysis or some other technique selected in accordance with the asset being analyzed), detect error conditions based on a model of the corresponding asset. In an example, a processor circuit applies analytics or algorithms at the machine module 110 or at the asset cloud computing system 120.

In response to the detected error conditions, the AMP can issue various mitigating commands to the asset, such as via the machine module 110, for manual or automatic implementation at the asset. In an example, the AMP can provide a shut-down command to the asset in response to a detected error condition. Shutting down an asset before an error condition becomes fatal can help to mitigate potential losses or to reduce damage to the asset or its surroundings. In addition to such an edge-level application, the machine module 110 can communicate asset information to the asset cloud computing system 120.

In an example, the asset cloud computing system 120 can store or retrieve operational data for multiple similar assets. Over time, data scientists or machine learning can identify patterns and, based on the patterns, can create improved physics-based analytical models for identifying or mitigating issues at a particular asset or asset type. The improved analytics can be pushed back to all or a subset of the assets, such as via multiple respective machine modules 110, to effectively and efficiently improve performance of designated (e.g., similarly-situated) assets.

In an example, the asset cloud computing system 120 includes a Software-Defined Infrastructure (SDI) that serves as an abstraction layer above any specified hardware, such as to enable a data center to evolve over time with minimal disruption to overlying applications. The SDI enables a shared infrastructure with policy-based provisioning to facilitate dynamic automation, and enables SLA (service level agreement) mappings to underlying infrastructure. This configuration can be useful when an application requires an underlying hardware configuration. The provisioning management and pooling of resources can be done at a granular level, thus allowing optimal resource allocation.

In a further example, the asset cloud computing system 120 is based on Cloud Foundry (CF), an open source PaaS (Platform-as-a-Service) that supports multiple developer frameworks and an ecosystem of application services. Cloud Foundry can make it faster and easier for application developers to build, test, deploy, and scale applications. Developers thus gain access to the vibrant CF ecosystem and an ever-growing library of CF services. Additionally, because it is open source, CF can be customized for IIoT workloads.

The asset cloud computing system 120 can include a data services module that can facilitate application development. For example, the data services module can enable developers to bring data into the asset cloud computing system 120 and to make such data available for various applications, such as applications that execute at the cloud, at a machine module, or at an asset or other location (such as a mobile device). In an example, the data services module can be configured to cleanse, merge, or map data before ultimately storing it in an appropriate data store, for example, at the asset cloud computing system 120. A special emphasis has been placed on time series data, as it is the data format that most sensors use.

Security can be a concern for data services that deal in data exchange between the asset cloud computing system 120 and one or more assets or other components. Some options for securing data transmissions include using Virtual Private Networks (VPNs) or an SSL/TLS (secure socket layer/transport layer security) model. In an example, the first AMP 100 can support two-way TLS, such as between a machine module and the security module 124. In an example, two-way TLS may not be supported, and the security module 124 can treat client devices as OAuth users. For example, the security module 124 can allow enrollment of an asset (or other device) as an OAuth client and transparently use OAuth access tokens to send data to protected endpoints.

In some examples, application programs for data distributing devices and/or data receiving devices are automatically converted (or partially converted) to application programs suitable for off-line applications. This may facilitate applications of AMPs in which mobile devices are deployed as data recipients. An output of the application program conversion process may be a mobile application or an application for operation on a device that supplies data to mobile devices. Devices that supply data to mobile devices may generally be referred to herein and in the appended claims as “servers” or “server computers”; the term “server” or “server computer” is to be understood broadly as encompassing asset cloud computing systems, enterprise systems, remotely-located server computers, and centralized computing resources; the terms “server” and “server computer” are applicable to data-supplying devices whether or not a client/server protocol is employed and whether or not the data-supplying device is located in a single location or distributed over multiple locations.

An application program or programs that perform or facilitate automatic conversion of other application programs for use in or with mobile devices may (a) parse a code listing of a program to be converted; (b) characterize segments of the code-listing; (c) generate adapter code lines to replace some of the original code listing segments; (d) determine that other original code listing segments are to be identified/annotated instead of being replaced. Annotations of original code listing segments may indicate (i) that manual coding is needed to convert the original code listing segments; (ii) a result of the characterization of an individual original code listing segment; and/or (iii) a suggestion of a manual coding approach to be used in converting an individual original code listing segment.

Substantially automated conversion of existing recipient or transmitting device application programs to applications suitable for use with mobile devices may reduce the cost of application conversion and thereby facilitate inclusion of mobile devices in AMPs such as that shown in FIG. 1 and/or accelerate advancement of the IIoT into use with mobile devices.

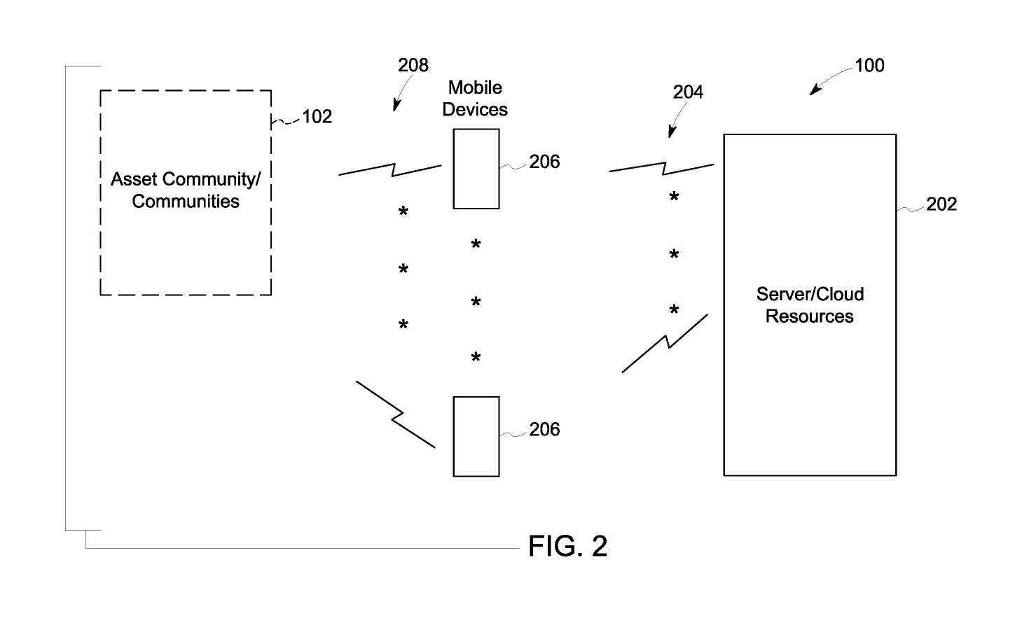

FIG. 2 is a high level block diagram showing other aspects of the AMP 100 depicted in FIG. 1.

As seen from FIG. 2, the AMP 100 may include a central source of data, labeled in the drawing as a server or one or more cloud computing resources and indicated by reference numeral 202. From prior discussion, it will be appreciated that the server/computing resource 202 may be all or part of the asset cloud computing system 120 or the enterprise systems 130 shown in FIG. 1 or may be another computing device or type of computing device.

As indicated schematically at 204 in FIG. 2, the server 202 may distribute data via wireless communications to numerous mobile devices 206. The communication channel(s) between the server 206 and the mobile devices 206 (which communication channels are not explicitly shown in the drawing) may include, for example, one or more mobile communication networks, as well as other communication networks such as the internet and/or one or more private networks and/or VPNs (virtual private networks). The above discussion of direct or other sorts of connectivity to the AMP is also pertinent.

In an example, all the data provided from the server 202 to the mobile devices 206 may be provided essentially for the purpose of providing an information feed to users (not shown) of the mobile devices. In an example, the mobile device users may be medical personnel who receive from the server 202 feeds of data generated by (or of data generated from analysis of data generated by) medical monitoring devices that sense vital signs and other indicators of the current and changing conditions of hospitalized patients. It will be understood, in connection with this example, that the medical monitoring devices (though not explicitly depicted) are to be considered among the assets of the AMP 100 as presented in FIG. 1.

In another example, the data fed from the server 202 to the mobile devices 206 may include operational indicators of assets of the AMP so that the users of the mobile devices 206 may be prompted to perform tasks relative to the assets such as visual inspections, mechanical tests and/or adjustments, setting of local control mechanisms for the assets, emergency shut-down procedures, rebooting of local electronic controllers, etc. The types of assets referred to in the previous sentence may include wind turbines, locomotives, jet engines, large pieces of medical diagnostic equipment, factory production equipment, power generation equipment that consumes fossil fuel to generate electricity, etc.

In an example, the server 202 (e.g., assuming it to include resources of the asset cloud computing system 120) may simultaneously deliver two or more different types of the data feeds referred to above to mobile devices employed by two, three or more different organizations/enterprises. In an example, the server 202 provides respective data feeds to numerous mobile devices 206 simultaneously or virtually simultaneously. In some examples, the same data feed may be provided simultaneously to a group of mobile devices 206 carried by individuals who share a common interest in the particular data feed. Returning, for example, to the medical monitoring example, several doctors or other medical professionals responsible for treating a certain patient may all receive the same feed of medical monitoring data for that patient. That feed may be received at the users' mobile devices interspersed with other data feeds containing medical monitoring data for other patients. The members of the above-mentioned group of medical professionals may receive over-all feeds that reflect the medical monitoring of different respective groups of patients, given that different professionals may be charged with caring for different groups of patients.

It may also be the case, where the data feeds represent asset operational indicators, that there may be groups of individuals who receive duplicate feeds for assets for which they share responsibility. At the same time, as in the medical example, some members of the group may receive data feeds for other assets that only they are responsible for, and the latter feeds may not be provided to members of the group not responsible for the last-mentioned assets.

In an example, as indicated schematically at 208, at least some of the mobile devices 206 may communicate data and/or control signals to assets in one or more asset communities 102. In an example, the communication from the mobile devices 206 may be via one or more machine modules 110 (per the above discussion of FIG. 1; machine module(s) not shown in FIG. 2). In an example, a mobile device 206 may simply relay data that it has received from the server 202 to an asset; the communication from the mobile device 206 to the asset may be via short-range radio communications, in some example. In another example, the mobile device 206 may, via an application program running in the mobile device, process data received from the server 202 to generate processed data and/or one or more control signals, which are in turn (processed data and/or control signals) communicated from the mobile device 206 to one or more assets. The asset(s) receiving the processed data/control signals from the mobile device 206 may be one or more of the types of AMP assets referred to above.

The communication channel(s) between the mobile devices 206 and the asset(s) (which communication channels are not explicitly shown in the drawing) need not be short-range communication channels. The communication channels between the mobile devices 206 and the asset(s) may include, for example, one or more mobile communication networks, as well as other communication networks such as the internet and/or one or more private networks and/or VPNs (virtual private networks).

In cases where the asset has a short-range data communication capability suitable for providing a communication channel to a nearby mobile device 206, the mobile device and the asset's short range communication capability may provide a backup channel in the event that normal communication channels between the asset and the asset cloud computing system 120 suffer an outage.

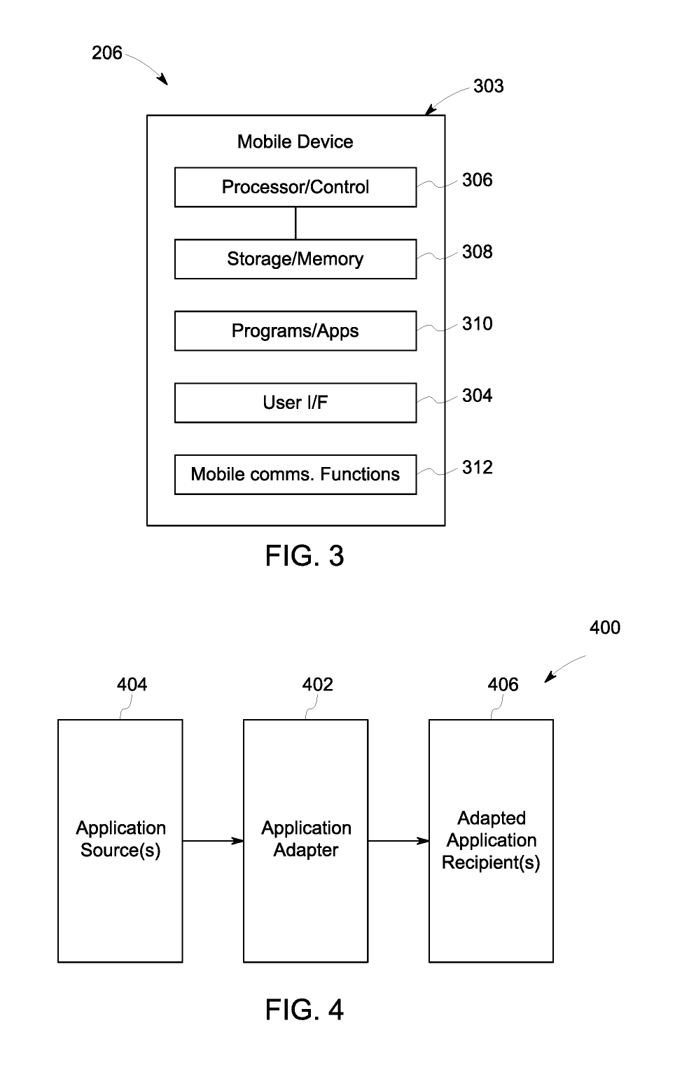

FIG. 3 is a block diagram of a typical mobile device 206 such as those shown in FIG. 2.

The mobile device 206 may include a housing 303. In many embodiments, the front of the housing 203 is predominantly constituted by a touchscreen (not separately shown), which is a key element of the user interface 304 of the mobile device 206.

The mobile device 206 further includes a mobile processor/control circuit 306, which is contained within the housing 303. Also included in the mobile device 206 is a storage/memory device or devices (reference numeral 308). The storage/memory devices 308 are in communication with the processor/control circuit 306 and may contain program instructions to control the processor/control circuit 306 to manage and perform various functions of the mobile device 206. In an example the program instructions may, at least in part, contain one or more mobile application programs (“apps”) that are automatically or semi-automatically generated by converting application programs originally written for non-mobile terminals (or mobile terminals operated with continuous communication connectivity) in an APM environment. Manners of generating such apps are described below. (The apps are represented at block 310 in FIG. 3, and may, along with other programs, in practice be stored in block 308, to program the processor/control circuit 306.)

As is typical for mobile devices, the mobile device 206 may include mobile communications functions as represented by block 312. The mobile communications functions may include voice and data communications via a mobile communication network with which the mobile device 206 is registered or with which it has been associated. Although not expressly indicated in the drawing, it should be noted that the mobile device 206 may also include capabilities for one or more different types of short-range communication (e.g., WiFi).

From the foregoing discussion, it will be appreciated that the blocks depicted in FIG. 3 as components of the mobile device 206 may in effect overlap with each other, and/or there may be functional connections among the blocks which are not explicitly shown in the drawing. It may also be assumed that, like a typical smartphone or tablet computer, the mobile device 206 may include a rechargeable battery (not shown) that is contained within the housing 303 and that provides electrical power to the active components of the mobile device 206.

While the mobile device 206 may be embodied as a smartphone or tablet computer, other hardware and form factor profiles may characterize the mobile device 206. For example, the mobile device may be embodied as a mobile terminal of one of the types issued by enterprises to their traveling technicians, delivery personnel, etc. Such a mobile terminal may feature, for example, a specially configured keypad/touchpad, tailored to suit the mission of the individuals to whom the terminal is issued. In the case of a mobile terminal issued to a technician, the mobile terminal may include relevant test equipment components, etc.

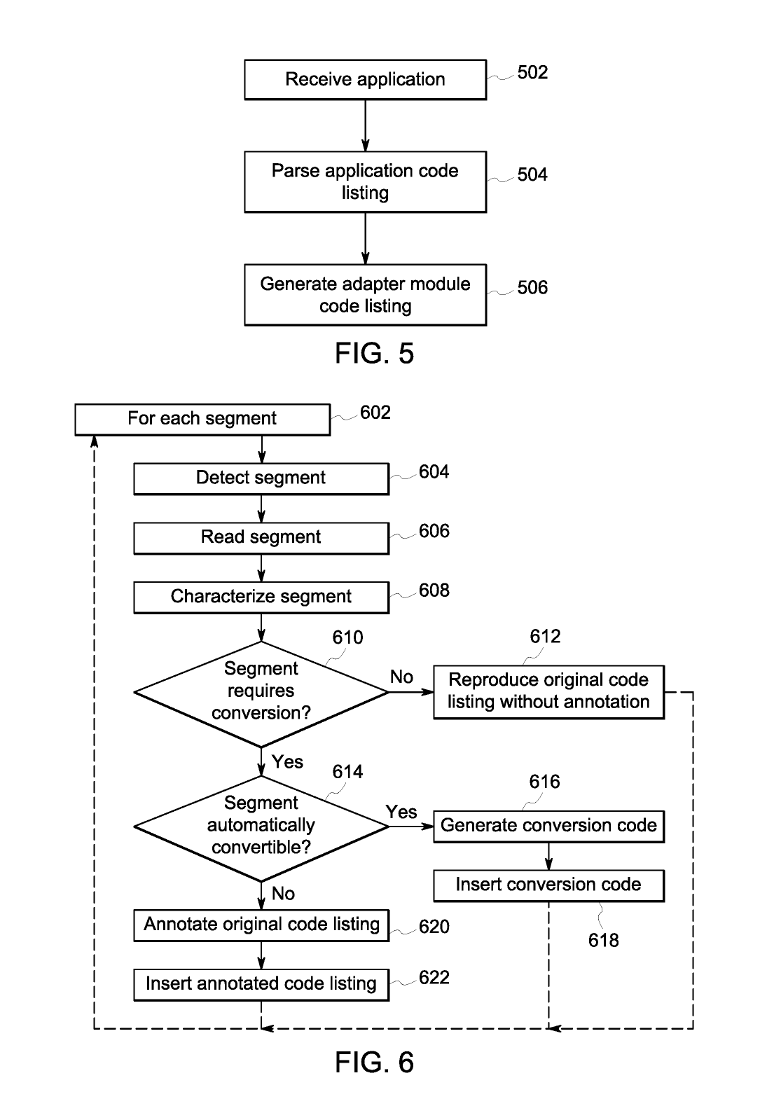

FIG. 4 is a block diagram of an automatic application program conversion system 400 according to some embodiments.

The application program conversion system 400 may include, for example, an application adapter computer system 402, provided according to some embodiments. The application adapter computer system 402 may be of particular relevance to the subject matter described herein and details thereof will be described below. To briefly describe functionality that may be provided by the application adapter computer system 402, it may convert/adapt—to mobile communication environments, such as that shown in FIG. 2—application programs that run on the asset cloud computing system 120 (or other source of data) and/or application programs that run on devices (e.g., terminal devices) that receive data from the asset cloud computing system 120 and are substantially continuously connected to the asset cloud computing system 120 for data communication therewith. The latter environment may be referred to as an “online” environment. The mobile communication environment illustrated in FIG. 2 may be referred to as an “offline” environment, in that communication between the server 202 (FIG. 2) and the mobile devices 206 may be subject to frequent and unpredictable interruptions, thereby rendering the mobile devices “offline” at times when the communication interruptions are in effect. (By contrast, in some operating environments, even where mobile devices are deployed, this may be in a contained area, such as an industrial or power plant, that may be thoroughly covered by a reliable wireless network, thereby rendering the plant an online environment, notwithstanding that at least some terminals are mobile.)

Block 404 in FIG. 4 represents a source of online environment application programs—i.e., the above-mentioned applications that run on the data source or the data-recipient terminals in the online environment. The online application program source 404 may provide online environment application programs from time to time to the application adapter computer system 402 for conversion to application programs suitable for use in the offline environment. The application adapter computer system 402 may perform the conversion automatically or semi-automatically in accordance with techniques disclosed herein. The resulting converted or partially-converted application programs may be provided from the application adapter computer system 402 to an application program recipient device 406, and the latter may then serve as a source for distributing/downloading converted application programs to mobile devices and/or data sources intended for operation in an offline environment.

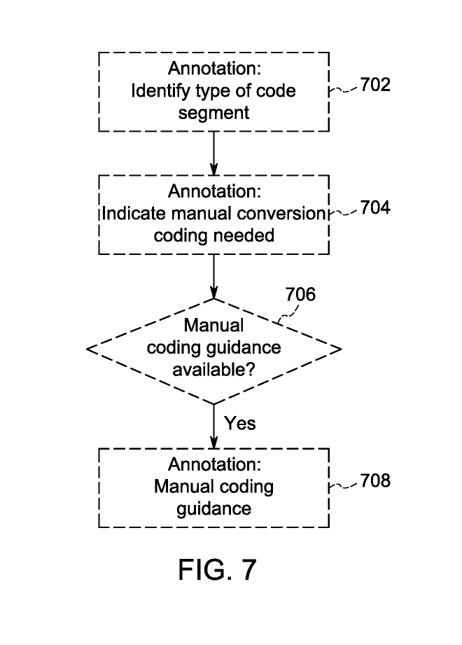

FIG. 5 is a high-level flow chart that illustrates a process that may be performed in/by the application adapter computer system 402.

At 502, the application adapter computer system 402 receives an application program to be converted. The application program may be received by the application adapter computer system 402 in the form of a code listing for the application program.

At 504, the application adapter computer system 402 may parse a code listing it has received at 502. As will be seen, the parsing of the code listing may be segment-by-segment, and may utilize a number of different capabilities of the application adapter computer system 402 to produce or aid in producing an adapted or converted application suitable for use in or with mobile devices operating in an offline environment. Block 506 represents generation by the application adapter computer system 402 of an adapter module code listing which is complete or may be fairly readily completable as an adapted or converted offline application program.

FIG. 6 is a flow chart that illustrates in more detail the process steps represented at 504 and 506 in FIG. 5.

As noted above, the parsing, processing and conversion of the received code listing by the application adapter computer system 402 may proceed via segment-by-segment through the code listing of the received application program. This segment-by-segment nature of the processing is represented at block 602 in FIG. 6 and by the generally iterative flow of the processing illustrated in FIG. 6.

For each segment, and as indicated at 604, the application adapter computer system 402 detects the starting and ending points of the segment. The application adapter computer system 402 may make determinations as to the starting and ending points of the segments based on a number of factors, such as the formatting of the code listing (e.g., including line-breaks and characters/punctuation signifying segment ends) and/or via a syntactic analysis of the contents of the code listing.

At 606, the application adapter computer system 402 reads the code listing segment that it has detected at 604. The application adapter computer system 402 may have been programmed to interpret the computer programming language in which the code listing was written, and to recognize the meanings of at least some of the programming language expressions contained in the code listing. To aid in the reading of the code listing by the application adapter computer system 402, it may have been programmed with a phrase book or dictionary for the programming language expressions that may appear in the code listing. In addition or alternatively, the application adapter computer system 402 may have been programmed/trained to recognize patterns in the code listing.

At 608, and based on its reading of the current code listing segment at 606, the application adapter computer system 402 may provide or produce a characterization and/or classification of the current code segment. Among the possible characterizations of the code listing segment that may be provided by the application adapter computer system 402 are perhaps the following: “does not require conversion”; “requires conversion”; “automatically convertible” (by the application adapter computer system 402); “not automatically convertible” (or “requires manual coding”): “data generation”; “data reading”; “data updating”; “data deleting”; “simple query”; “complex query”; “data transmission”; “data receiving”. In an example, for at least some code listing segments, the application adapter computer system 402 may apply two or more of these characterizations to the code listing segment. In some examples, other or different characterizations or types of characterizations may be programmed into the application adapter computer system 402 for application to code listing segments. The characterization of the code listing segment made by the application adapter computer system 402 may be based on the code listing segment as read by the application adapter computer system 402.

In the process of FIG. 6, a decision block 610 may follow block 610. At decision block 610, the application adapter computer system 402 may determine whether it is appropriate/necessary that the current code listing segment be converted to feature other or additional program code than is originally present in the current code listing segment. In an example, the determination made at decision block 610 may be based on a characterization of the current code listing segment that was made at block 608.

If a negative determination is made at decision block 610 (i.e., if the application adapter computer system 402 determines that conversion is not required for the current code listing section), then block 612 may follow decision block 610. At block 610, the application adapter computer system 402 may include the original content of the current code listing segment in the converted/adapted application code listing that is to be the output of the process of FIG. 5. In this case, the application adapter computer system 402 may refrain from annotating the code listing segment as included in the converted/adapted application code listing. (Annotation of code listing segments is a capability that may be possessed by the application adapter computer system 402 and will be described below.) After block 612, the process of FIG. 6 may loop back to 602 for processing of the next code listing segment.

If a positive determination is made at decision block 610 (i.e., if the application adapter computer system 402 determines that conversion of the current code listing section is required), then decision block 614 may follow decision block 610.

At decision block 614, the application adapter computer system 402 may determine whether the current code listing segment is amenable to automatic conversion by the application adapter computer system 402. In an example, the determination made at decision block 614 may be based on a characterization of the current code listing segment that was made at block 608. More specifically, the application adapter computer system 402 may make the determination at block 614 based on an algorithm that assesses the nature of the code within the current code listing segment and compares the nature of the code with the code conversion capabilities of the application adapter computer system 402.

If a positive determination is made at decision block 614 (i.e., if the application adapter computer system 402 determines that the current code listing segment is amenable to automatic conversion), then block 616 may follow decision block 614. At block 616, the application adapter computer system 402 may generate a suitable replacement code listing segment to replace the current code listing segment. In an example, the application adapter computer system 402 may have been programmed to have a translation capability for translating code listing segments suitable only for online environment application programs into code listing segments suitable for performing the same or a similar function in an offline environment. In some situations, the replacement code listing segment may include portions of the original code listing segment but may have portions of program code inserted therein to adapt the code listing segment to the offline environment. For example, if the code listing segment embodies a simple query, the replacement code listing segment may be suitable for causing the simple query to be performed in a manner that is consistent with operation in an offline environment. Similar translations/adaptations may be performed, for example, with respect to code listing segments that embody functions such as data transmission or data reception.

In another example, conversion of an original code listing segment may include augmenting the original code listing segment to perform an additional function or functions such as transforming a data object or resource from one format to another. For example, the additional function may transform a comma delimited file into serialized data and may package the serialized data for transmission in an offline environment.

In another example, conversion of an original code listing segment that contains a query function may result in a replacement code listing segment that provides a function for submitting a query in the form of asking for a service according to a client/server protocol.

In general, for example, where an original code listing segment performs a function in accordance with a standard RESTful Web service approach (where “REST” stands for Representational State Transfer), the application adapter computer system 402 may be capable of readily translating the original code listing—at least in many cases—to a replacement code listing segment that is suitable for performing the function in an offline environment.

Block 618 may follow block 616 in the process of FIG. 6. At block 618, the application adapter computer system 402 may include the replacement code listing segment (as generated at block 616) in the converted/adapted application code listing that is to be the output of the process of FIG. 5. It should be noted that the replacement code listing segment may take the place of the current original code listing segment in the code listing that is to be produced by the process of FIG. 5. After block 618 the process of FIG. 6 may loop back to 602 for processing of the next code listing segment.

If a negative determination is made at decision block 614 (i.e., if the application adapter computer system 402 determines that the current code listing segment is not amenable to automatic conversion), then block 620 may follow decision block 614 in the process of FIG. 6. At block 620, the application adapter computer system 402 may apply an annotation process to the current code listing segment. Examples of annotation processes that may implement block 620 will now be described with reference to FIG. 7. FIG. 7 schematically illustrates, in flow chart form, a number of alternative annotation processes that may be performed at block 620.

Referring then to FIG. 7, block 702 represents one variety of annotation processing that may be performed, in some examples, at block 620. At block 702, the application adapter computer system 402 may append an annotation to the current code listing segment for the purposes of indicating a type or classification of the current code listing segment, as may have been determined, for example, at block 608. For example, the annotations of this type may indicate that the current code segment listing constitutes functionality such as data generation, data reading, data updating, data deleting, simple query, complex query, data transmission or data receiving. This annotation may be in plain natural language text (e.g., in English), and may have the benefit of informing a manual coding expert what sort of code conversion task may be encountered in manually coding an adapted version of the current code listing segment.

Continuing to refer to FIG. 7, block 704 represents another variety of annotation processing that may be performed, in some examples, at block 620. At block 704, the application adapter computer system 402 may append an annotation to the current code listing segment for the purpose of indicating that manual coding is required for conversion of the current code listing segment. This annotation may read, simply, “MANUAL CONVERSION CODING NEEDED”. The inclusion of this annotation may reflect outcomes of the processing performed at blocks 608, 610 and 614. This annotation may be useful to a manual coding expert by calling out original, unconverted code listing segments that require conversion but that were beyond the automatic conversion capabilities of the application adapter computer system 402.

In an example, the process illustrated in FIG. 7 also may include a decision block 706. At the decision block 706, the application adapter computer system 402 may determine whether the current code listing segment is of a type such that the application adapter computer system 402 has been programmed to have available manual coding guidance for code listing segments of the same kind as the current code listing segment. In an example, the application adapter computer system 402 may make this determination based on the characterization of the current code listing segment as performed at block 608 (FIG. 6). In an example, code listing segments that contain complex queries may be beyond the automatic conversion capabilities of the application adapter computer system 402, but there may be a text paragraph or paragraphs available and stored in the application adapter computer system 402 that describes manual coding strategies or approaches that are likely to be helpful to a manual coder in converting code listing segments of this kind.

Referring again to FIG. 7, if a positive determination is made at decision block 706 (i.e., if the application adapter computer system 402 determines that manual coding guidance is available for the current code listing segment), then the process of FIG. 7 may advance from decision block 706 to block 708.

Again, block 708 represents one variety of annotation processing that may be performed at block 620 (FIG. 6). At block 708, the application adapter computer system 402 may append an annotation to the current code listing segment for the purpose of providing guidance to a manual coder as to how to go about writing code to convert the current code listing segment to an adapted/converted code listing segment that is suitable for inclusion in a converted application program for use in an offline environment. In an example, the annotation may include or consist of one or more paragraphs of explanatory natural language text that may provide the desired guidance to the manual coder. In addition or alternatively, the annotation may include a hyperlink that points to an online resource that provides such guidance. In each case, it is to be understood that the guidance provided or pointed to by the annotation may be selected to be relevant to code listing segments of the type to which the current code listing segment belongs.

In various examples, any one or more or all of the types of annotations described with reference to FIG. 7 may be implemented at block 620 (FIG. 6).

Reference will now be made once again to FIG. 6. In the process of FIG. 6, block 622 may follow block 620. At block 622, the application adapter computer system 402 may include the original content of the current code listing segment in the converted/adapted application code listing segment that is to be the output of the process of FIG. 5. Also included with the original current code listing may be the annotation or annotations appended to the current code listing via the processing at block 620. After block 620, the process of FIG. 6 may loop back to 602 for processing of the next code listing segment.

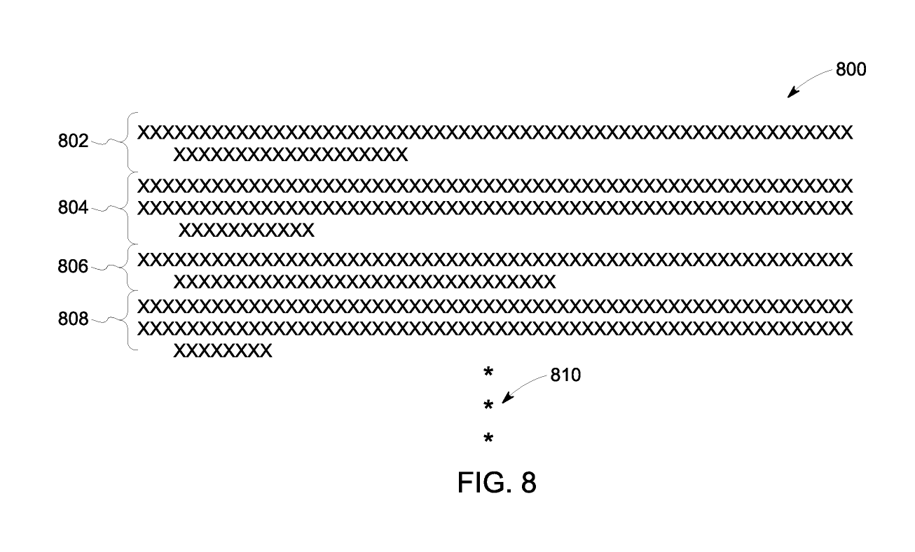

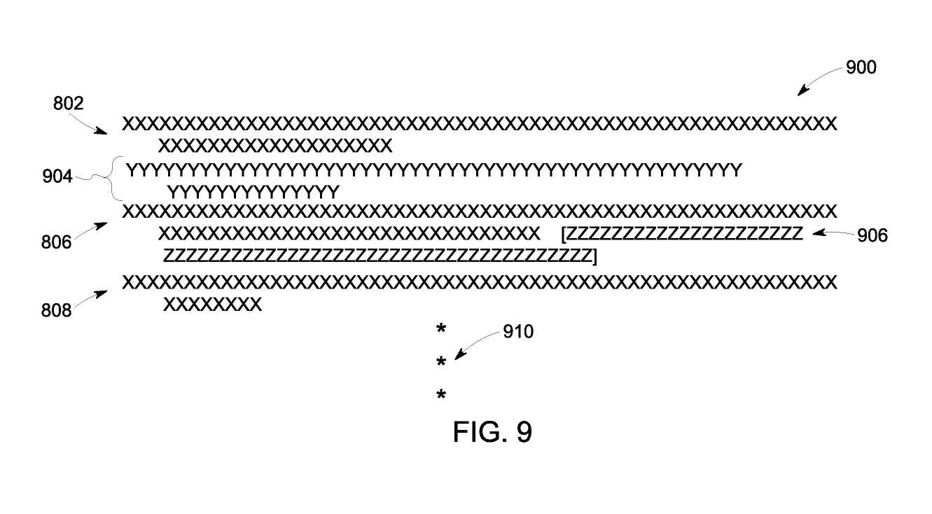

A simplified example of code listing conversion according to teachings of this disclosure will now be illustrated and described with reference to FIGS. 8 and 9. FIG. 8 schematically illustrates an application program code listing to be processed by the application adapter computer system 402. FIG. 9 schematically illustrates a converted/partially converted application program code listing generated by the application adapter computer system 402 from the code listing of FIG. 8 via one or more of the processes described above with reference to FIGS. 5-7.

Referring initially to FIG. 8, a code listing 800 is schematically shown. The code listing 800 is intended to represent an application program code listing for an application program available for use and perhaps deployed for use in an online environment. The application program in question may, for example, be intended for programming a source of data (such as the asset cloud computing system 120) in the AMP 100 or for programming a terminal device that receives data from a source of data in the AMP 100. In FIG. 8, code listing segments 802, 804, 806 and 808 of the code listing 800 are shown. It is noted that each code listing segment may consist of one, two or more lines of program code. The ellipsis 810 in FIG. 8 is indicative that the code listing 800 may include further code listing segments beyond those schematically presented in FIG. 8. The code listing segments 802, 804, 806 and 808 may be thought of as “original” code listing segments in that they may be subjected to conversion processing by the application adapter computer system 402 according to one or more teachings of this disclosure.

In FIG. 9, an example of a converted/adapted code listing 900 is schematically shown. For purposes of this example, it is assumed that the process of FIG. 6 resulted in a determination by the application adapter computer system 402 that code listing segment 802 did not require conversion. Accordingly, FIG. 9 shows the original code listing segment 802 included in the code listing 900.

It is further assumed for the purposes of this example that the process of FIG. 6 resulted in a determination by the application adapter computer system 402 that code listing segment 804 (FIG. 8) required conversion and that the application adapter computer system 402 was capable of performing the conversion. Accordingly, the application adapter computer system 402 is assumed to have generated a replacement code listing segment 904 (FIG. 9) to take the place of original code listing segment 804. It may be understood that the replacement code listing segment 904 may perform essentially the same function or functions as the original code listing segment 804, but may do so in a manner that is effective in an offline environment.

According to a further assumption for the purposes of this example, the process of FIG. 6 resulted in a determination by the application adapter computer system 402 that code listing segment 806 (FIG. 8) required conversion but that the application adapter computer system 402 was not capable of performing the required conversion as to code listing segment 806. It is further assumed that the processing of blocks 620 and 622 (and FIG. 7) resulted in the application adapter computer system 402 appending an annotation 906 to the original code listing segment 806. (The annotation 906 may be one or more of the types of annotation described above in connection with FIG. 7.) Accordingly, the original code listing segment 806 and its appended annotation 906 appear in FIG. 9 as part of the code listing 900. It will be appreciated that a replacement code listing segment (not shown) may need to be manually written to take the place of original code listing segment 806 in order to complete the conversion of the code listing 800. In one or more examples, the annotation 906 may aid in the subsequent manual coding by (a) flagging the code listing segment 806 in code listing 900 as being in need of manual conversion; (b) indicating a characterization applied by the application adapter computer system 402 to the code listing segment 806; and/or (c) providing guidance to the manual coder as to how to go about writing the replacement code listing section that is needed to replace the original code listing segment 806.

As to the original code listing segment 808, it is again assumed, as was the case with code listing segment 802, that the process of FIG. 6 resulted in a determination by the application adapter computer system 402 that code listing segment 808 did not require conversion. Accordingly, FIG. 9 shows the original code listing segment 808 included in the code listing 900.

The ellipsis 910 shown in FIG. 9 is intended to indicate that the code listing 900 further includes additional code listing segments that correspond to the additional code listing segments of code listing 800 (FIG. 8). The additional code listing segments represented by the ellipsis 910 in FIG. 9 may be, depending on the outcomes of the process of FIG. 6 with respect to the original code listing segments, either the original code listing segments (with or without annotation) or replacement code listing segments that were generated in the process of FIG. 6, as described above.

Once any required manual coding is accomplished for the original code listing segments that were found to require conversion but which the application adapter computer system 402 was not capable of converting, an adapted/converted application program has been produced. The adapted/converted application program may be suitable for running in a source of data or a mobile device, as the case may be, and may be suitable for use in an offline environment. The conversion of the original application program may have been accomplished with a high degree of automation, thereby lowering the cost and reducing the time required to produce/convert application programs for an offline environment. This may help to spur or expand the deployment of mobile devices in Asset Management Platform systems. This in turn may increase the capabilities and convenience offered in AMP systems.

The following summarizes various capabilities of the application adapter computer system 402, as illustrated above with reference to FIGS. 6 and 7.

The application adapter computer system 402 may be capable of detecting characteristics of various types of code listing segments encountered in the application programs to be processed/converted for use in an offline environment. For code listing segments found to have certain characteristics, the application adapter computer system 402 may generate a replacement code listing segment to take the place of the original code listing segment. The replacement code listing segment may be suitable for an application program to be deployed in an offline environment.

As to code listing segments found to have other characteristics, the application adapter computer system 402 may refrain from generating replacement code listing segments. As to the latter types of original code listing segments, the application adapter computer system 402 may list the original code listing segment for the code listing for the adapted/converted application program, together with an indication that manual coding of the particular original code listing segment is required.

The application adapter computer system 402 may be capable of machine-reading a code listing on a segment-by-segment basis. (The code listing may represent an application program.) The application adapter computer system 402 may determine for each code listing segment whether or not to automatically generate corresponding adapter program code to replace the original code listing segment.

In addition to the above-mentioned machine-reading capability, and while the machine reading is going on, the application adapter computer system 402 may determine, for a given code listing segment, that the segment is of a predetermined type. In response to that determination, the application adapter computer system 402 may automatically append, to a code listing for an adapted/converted program, an indication of a suggested manual coding approach for converting the particular original code listing segment to a converted code listing segment for use in the adapted/converted program code listing. In addition or alternatively, the application adapter computer system 402 may append to the code listing for the adapted/converted program an indication of what is the type of the original code listing segment.

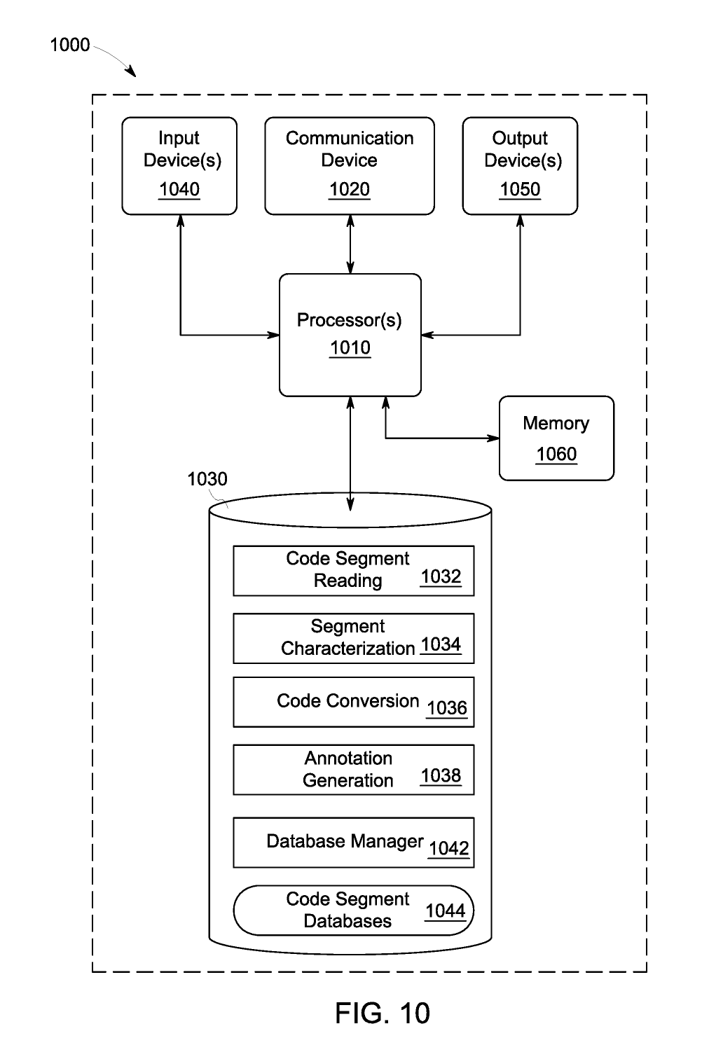

Computer 1000 shown in FIG. 10 is an example hardware-oriented representation of the application adapter computer system 402 shown in FIG. 4.

Referring to FIG. 10, computer 1000 includes one or more processors 1010 operatively coupled to communication device 1020, data storage device 1030, one or more input devices 1040, one or more output devices 1050 and memory 1060. Communication device 1020 may facilitate communication with external devices, such as a reporting client, or a data storage device, or a device that receives and stores adapter/converted application programs or supplies original application programs for conversion. Input device(s) 1040 may include, for example, a keyboard, a keypad, a mouse or other pointing device, a microphone, knob or a switch, an infra-red (IR) port, a docking station, and/or a touch screen. Input device(s) 1040 may be used, for example, to enter information into the computer 1000. Output device(s) 1050 may include, for example, a display (e.g., a display screen), a speaker, and/or a printer.

Data storage device 1030 may include any appropriate persistent (i.e., non-transitory) storage device, including combinations of magnetic storage devices (e.g., magnetic tape, hard disk drives and flash memory), optical storage devices, Read Only Memory (ROM) devices, etc., while memory 1060 may include Random Access Memory (RAM). The data storage device 1030 and the memory 1060 may be in communication with each other and/or with the processor(s) 1010.

Data storage device 1030 may store software programs that include program code executed by processor(s) 1010 to cause computer 1000 to perform any one or more of the processes described herein. Embodiments are not limited to execution of these processes by a single apparatus. For example, the data storage device 1030 may store code segment reading software 1032.

Continuing to refer to FIG. 10, data storage device 1030 may also store code segment characterization software 1034.

In addition, data storage device 1030 may store a software program 1036, which generates segments of replacement code.

Still further, data storage device 1030 may store a software program 1038 which generates annotations for inclusion in adapter/converted application program code listings.

Also, data storage device 1030 may store a database manager program 1042 and one or more code listing segment databases 1044, which may be processed or stored in the computer 1000. Data storage device 1030 may store other data and other program code for providing additional functionality and/or which are necessary for operation of system computer 1000, such as device drivers, operating system files, etc.

A technical effect is to provide at least partial machine-based analysis and conversion of application programs for deployment in offline environments.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

The flow charts and descriptions thereof herein should not be understood to prescribe a fixed order of performing the method steps described therein. Rather the method steps may be performed in any order that is practicable, including simultaneous performance of steps.

Embodiments described herein are solely for the purpose of illustration. A person of ordinary skill in the relevant art may recognize other embodiments may be practiced with modifications and alterations to that described above.

What is claimed is:

1. A method comprising:
machine-reading a first code listing, said first code listing representing at least a portion of an application program, said machine-reading proceeding through a plurality of segments of said first code listing;
determining, by a processor, during said machine-reading, with respect to one of said plurality of segments, that said one of said plurality of segments is of a predetermined type; and
in response to said determining, automatically appending, to a second code listing, an indication of a suggested manual coding approach for converting said one of said plurality of segments to a converted segment for use in said second code listing.

2. The method of claim 1, wherein said second code listing represents at least a portion of an adapted application program.

3. The method of claim 2, wherein the adapted application program is for performing at least one function in a server computer.

4. The method of claim 3, wherein said at least one function includes transmitting data to mobile devices.

5. The method of claim 2, wherein the adapted application program is for performing at least one function in a mobile device.

6. The method of claim 5, wherein said at least one function includes receiving data from a server computer.

7. The method of claim 1, wherein said application program is for performing at least one program in a remote device substantially continuously coupled for data communication with a server computer.

8. A method comprising:
machine-reading a first code listing, said first code listing representing at least a portion of an application program, said machine-reading proceeding through a plurality of segments of said first code listing;
determining, by a processor, during said machine-reading, with respect to one of said plurality of segments, that said one of said plurality of segments is of a predetermined type; and
in response to said determining, automatically appending, to a second code listing, a result of the determining step.

9. The method of claim 8, wherein said result is a characterization of said one of said plurality of segments.

10. The method of claim 8, wherein said second code listing represents at least a portion of an adapted application program.

11. The method of claim 10, wherein the adapted application program is for performing at least one function in a server computer.

12. The method of claim 11, wherein said at least one function includes transmitting data to mobile devices.

13. The method of claim 10, wherein the adapted application program is for performing at least one function in a mobile device.

14. The method of claim 13, wherein said at least one function includes receiving data from a server computer.

15. The method of claim 8, wherein said application program is for performing at least one function in a remote device substantially continuously coupled for data communication with a server computer.

16. An apparatus comprising:
a processor; and
a memory in communication with the processor, the memory storing program instructions, the processor operative with the program instructions to perform functions as follows:
machine-reading a first code listing, said first code listing representing at least a portion of an application program, said machine-reading proceeding through a plurality of segments of said first code listing;
determining, during said machine-reading, with respect to one of said plurality of segments, that said one of said plurality of segments is of a predetermined type; and
in response to said determining, appending, to a second code listing, an indication of a suggested manual coding approach for converting said one of said plurality of segments to a converted segment for use in said second code listing.

17. The apparatus of claim 16, wherein said second code listing represents at least a portion of an adapted application program.

18. The apparatus of claim 17, wherein the adapted application program is for performing at least one function in a server computer.

19. The apparatus of claim 18, wherein said at least one function includes transmitting data to mobile devices.

20. The apparatus of claim 17, wherein the adapted application program is for performing at least one function in a mobile device.
